(19) United States
(12) Patent Application Publication
(10) Pub. No.: US 2005/0025876 A1
(43) Pub. Date: Feb. 3, 2005

(54) Sausage product and method for producing sausage

(76) Inventor: Stewart Hicks, Lubbock, TX (US)

Correspondence Address: DAVID G. HENRY, 900 Washington Avenue, 7th Floor, P.O. Box 1470, Waco, TX, 77603-1470, US

(21) Appl. No.: 10/632,523

(22) Filed: Aug. 1, 2003

(51) Int. Cl. A23G 1/00

(52) U.S. Cl. 426/646

(57) ABSTRACT

A cost effective, time effective, and environmentally friendly sausage product and process for making sausage. Embodiments include a unique meat emulsion comprised of lean meat mixture, powdered vinegar, and encapsulated food grade acid. The process of combining these ingredients, and the resultant product itself, provide a distinct advantage. That is, combination of these ingredients prevents the meat emulsion from falling apart during the curing process, particularly when the meat emulsion is cured by naturally smoking the meat. The process of the present invention is thought to be most useful for ensuring that the meat emulsion remains intact during the curing process thereby reducing production time and costs, and eliminating wasted production materials.

### BACKGROUND OF THE INVENTION

1. Field of the Invention

Applicant's invention generally relates to an improved method for preparing a sausage product, and more particularly it relates to a method for making Chorizo. Chorizo sausage is a highly seasoned, coarsely ground pork or beef sausage flavored with garlic, chili powder and other spices. It is widely used in both Mexican and Spanish cookery.

The present invention, in its most preferred form, relates to a sausage production method, wherein the sausage is naturally smoked, and wherein the combination of particularly lean meat, powdered vinegar, and food-grade acid allows the sausage to remain intact rather than falling apart during the curing or smoking process.

2. Background Information

Traditionally, sausages are prepared by injecting or inserting sausage paste or meat into a prepared sausage casing and letting the meat dry or cure by smoking the product. Such casings are usually made from sheep or pig intestines, regenerated cellulose, or regenerated collagen. It is often desirable to naturally smoke a sausage product to impart a smokey flavor and color into the product. While natural smoke provides a better smoke flavor and color to the sausage product, the process of naturally smoking Chorizo sausage can be difficult. That is, Chorizo sausage often falls apart during the smoking step of the sausage making process. The proportions of meat to fat, the meat's cut, and seasoning variations all may adversely affect the meat's ability to stay together during the smoking process. This problem results in a great inefficiency in the sausage making process both with respect to economics and the environment. Commonly, entire batches of sausage are lost due to the meat falling apart within the casing during the smoking process. As such, entire batches of sausage must be discarded and the process restarted from scratch. As sausage making is a time consuming process, a large sum of money is lost in paying workers to do the same job more than once. Moreover, the discarded materials may not be used again so they are often thrown out, unnecessarily adding to an ever-increasing environmental problem.

Accordingly, a need exists for an improved method for producing sausage whereby the sausage will maintain its structural integrity during the smoking process and where the sausage making process is both efficient with respect to time and production costs and where the process does not create unnecessary production waste and where the sausage will maintain all of the benefits of naturally smoked sausage.

### SUMMARY OF THE INVENTION

In view of the foregoing, it is an object of the present invention to provide a method of sausage production where the sausage maintains its structural integrity during the smoking process

It is another object of the present invention to provide a cost effective method of sausage production

It is another object of the present invention to provide a time effective method of sausage production

It is another object of the present invention to provide a method of sausage production that reduces adverse effects on the environment through the elimination of wasted production materials.

It is another object of the present invention to provide a sausage product where the sausage maintains its structural integrity during the smoking process

It is another object of the present invention to provide a sausage product that is cost effective to produce

It is another object of the present invention to provide a sausage product that is time effective to produce

It is yet another object of the present invention to provide a sausage product that reduces adverse effects on the environment through the elimination of wasted production materials.

In satisfaction of these and related objectives, Applicant's invention permits its practitioner to incorporate a novel combination of ingredients and techniques when making sausage. This combination ensures that the structural integrity of the sausage will be maintained during the smoking process. As will be discussed in the specification to follow, practice of the invention involves preparing the sausage meat or paste mixture with particularly lean meat. Traditional Chorizo sausage is typically prepared with approximately a one-to-one meat to fat ratio. However, the present invention incorporates a meat or paste mixture with a 5-45 percent fat content, preferably 25 percent. In combination with this lean meat or paste mixture, the process of the present invention substitutes powdered vinegar in lieu of the generally accepted liquid form of vinegar. Use of powdered vinegar substantially increases the tendency of the meat or paste to remain intact while maintaining the flavor and color associated with traditional Chorizo. Further, the process of the present invention incorporates use of encapsulated food-grade acid to further ensure the structural integrity of the sausage during the smoking process. Preferably, the process of the present invention incorporates the use of encapsulated citric acid. This described combination virtually ensures that the sausage meat or paste will remain intact during the smoking process.

Use of the process of the present invention further provides economic and environmental advantages. That is, the process of the present invention is cost effective and time effective. The combination of ingredients and techniques that make this preparation method novel has a nominal impact on both preparation time and preparation costs. As such, production costs can be reduced. Further, the process of the present invention prevents wasted production material associated with sausage that has lost its structural integrity. As such, employment of the present invention will reduce some of the adverse environmental impact associated with traditional sausage making.

### BRIEF DESCRIPTION OF THE DRAWINGS

Applicant's invention may be further understood from a description of the accompanying drawings wherein, unless otherwise specified, like reference numbers are intended to depict like components in the various views.

FIG. 1 is a diagram view of the preferred embodiment of meat emulsion 10 containing lean meat mixture 12, powdered vinegar 14, and encapsulated food-grade acid 16.

FIG. 2 is a standard sausage-making machine of the preferred embodiment as known in the art.

### DETAILED DESCRIPTION OF THE PREFERRED EMBODIMENT

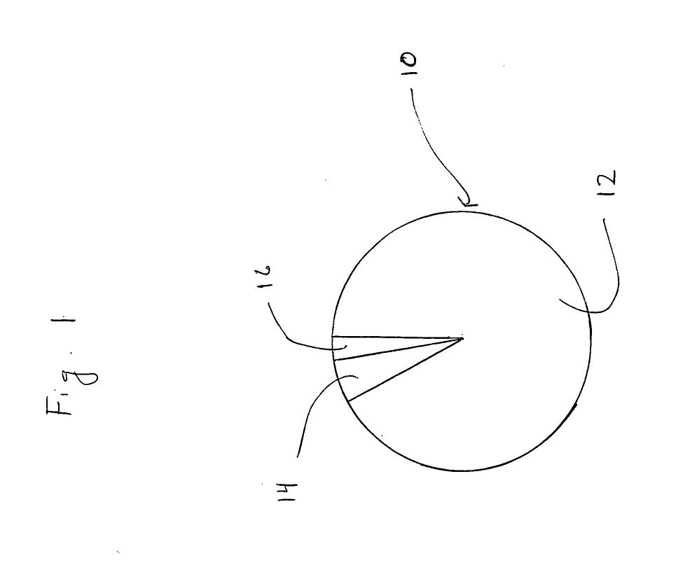

Referring to FIG. 1, a meat emulsion of the process of the present invention is generally referred to by numeral 10. Meat emulsion 10 is formed by combination of a lean meat mixture 12, powdered vinegar 14, and an encapsulated food-grade acid 16. Traditional Chorizo sausage is made from a combination of pork or beef and lard, typically with a meat-to-fat ratio of one to one. This type of meat mixture often falls apart during the curing process, particularly when the meat mixture is naturally smoked. In the preferred embodiment, lean meat mixture 12 is comprised of a relatively lean (fat content between 5 and 45 percent, preferably 25 percent) combination of pork or beef and animal fat. Using this relatively lean combination of meat and fat has been found, in combination with other soon to be described ingredients, to substantially increase the ability of meat emulsion 10 to remain intact during the curing process. However, one could easily imagine a meat mixture comprised of a combination of almost any type of meat and lard that would be acceptable for sausage making as virtually any meat mixture could be improved by the process of the present invention.

In the preferred embodiment, powdered vinegar 14 is used in combination in meat emulsion 10. Powdered vinegar is preferred because it substantially reduces the moisture content of meat emulsion 10 and greatly improves the ability of meat emulsion 10 to remain intact during the curing process. However, use of powdered vinegar 14 does not adversely affect the flavor, color, or texture of the resultant sausage product.

Use of a food grade acid is also used in combination in meat emulsion 10. In the preferred embodiment, encapsulated citric acid is used as this has produced the best results. Use of food-grade acid in the sausage making process is known in the art. However, when an encapsulated form of food-grade acid is used in the process of present invention, the results are greatly improved. That is, encapsulated food-grade acid, in combination with the above mentioned ingredients, produce a meat emulsion that virtually never falls apart during the curing process. Such result is not achieved by any known combination in the art.

Meat emulsion 10 has been described only with reference to the combination of lean meat mixture 12, powdered vinegar 14, and encapsulated food-grade acid 16. However, other ingredients certainly may be added according to desired, taste, texture, etc without reducing the effectiveness of the claimed invention.

Any particular mechanical process of making sausage does not limit the process of the present invention. Rather, the critical aspect of this sausage making process is the combination of the constituent ingredients that ensure the structural integrity of meat emulsion 10 during the curing process. However, an example of the process of the present invention used with a traditional or accepted mechanical method of sausage production is as follows.

The ingredients of meat emulsion 10 may be combined in any standard fashion according to accepted practices in the art, within any standard sausage-making machine (an example to be described) used in the art. An example would be 100 parts meat mixture, five parts powdered vinegar, two parts encapsulated food-grade acid, and a combination of other spices such as garlic and chili powder according to flavor. Although only one specific recipe has been provided for demonstration when used with the process of the present invention, modifications of other such recipes will become apparent to those skilled in the art in light of the present invention.

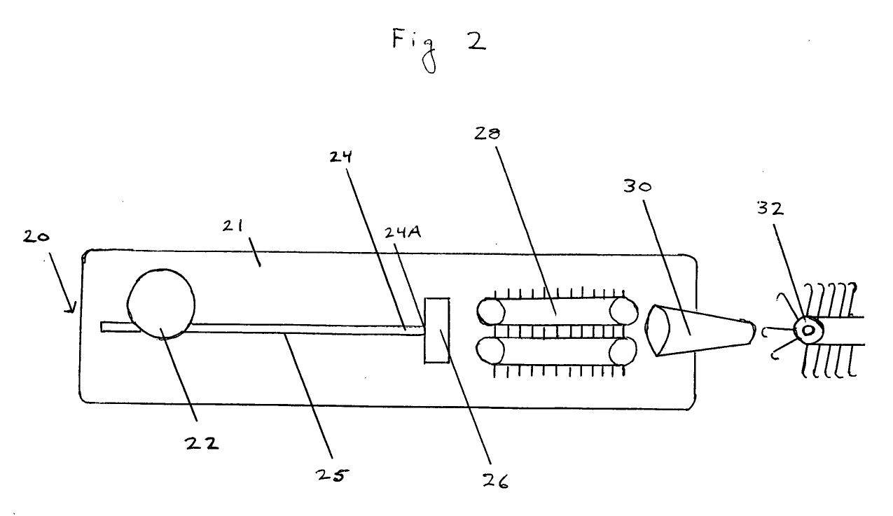

With reference to FIG. 2, a conventional sausage making machine 20 has a frame 21, a pump 22 connected to a source of emulsion (not shown), a slidable stuffing tube 24 surrounded by sausage casing 25, a twisting mechanism 26, a linking mechanism 28, a discharge horn 30, and a conveyor 32.

Meat emulsion 10 is pumped through tube 24 by pump 22 shown in FIG. 2. Meat emulsion 10 is encased in casing 25, which is placed on the outer surface of the tube 24 and extends to the discharge end 24A of tube 24. Stuffing tube 24 moves onto twister 26 while emulsion is conventionally being pumped into the interior of the casing 25 through tube 24. Casing 25 is formed into a linked product by the cooperative activity of twisting mechanism 26 and linking mechanism 28. Twisting mechanism 26 twists the elongated sausage strand filled within casing 25. Linking mechanism 26 divides the strand into a plurality of sausage links thereby creating an elongated linked encased sausage strand. The linked product is delivered through horn 30 to conveyor 32.

The elongated linked encased sausage strand is then sent to curing mechanism 34. In the preferred embodiment, curing mechanism 34 is the application of natural smoke as known in the art. However, the present invention is also useful when used with other curing mechanisms as will be apparent to those skilled in the art.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A method of making sausage, comprising,
combining a plurality of ingredients including, but not limited to, a lean meat mixture, powdered vinegar, and an encapsulated food-grade acid to form a meat emulsion,
extruding the meat emulsion from a tube into a tubular casing to create an encased sausage strand,
linking the encased sausage strand into a linking mechanism to divide the strand into a plurality of sausage links thereby creating an elongated linked encased sausage strand, and
curing the elongated linked encased sausage strand to eradicate bacteria and impart color and flavor to the meat emulsion.

2. The method of claim 1 wherein the curing is done by naturally smoking the sausage strand.

3. The method of claim 1 wherein the food-grade acid is encapsulated citric acid.

4. A sausage product made from the process, comprising:
combining a plurality of ingredients including, but not limited to, a lean meat mixture, powdered vinegar, and an encapsulated food-grade acid to form a meat emulsion,
extruding the meat emulsion from a tube into a tubular casing to create an encased sausage strand,
linking the encased sausage strand into a linking mechanism to divide the strand into a plurality of sausage links thereby creating an elongated linked encased sausage strand, and
curing the elongated linked encased sausage strand to eradicate bacteria and impart color and flavor to the meat emulsion.

5. The sausage product of claim 4, wherein the curing is done by naturally smoking the sausage strand.

6. The sausage product of claim 4, wherein the encapsulated food-grade acid is encapsulated citric acid.
